(19) United States
(12) Patent Application Publication
(10) Pub. No.: US 2023/0209156 A1
(43) Pub. Date: Jun. 29, 2023

(54) Methods and Systems for Managing Body-Worn Video Recording Devices

(71) Applicant: Digital Barriers Services, Ltd., London (GB)

(72) Inventors: Robert LAMBERT, London (GB); Mark ADAMSON, London (GB); Steven HARRIS, London (GB)

(21) Appl. No.: 18/087,921

(22) Filed: Dec. 23, 2022

Related U.S. Application Data
(60) Provisional application No. 63/294,003, filed on Dec. 27, 2021.

(51) Int. Cl. H04N 23/50; H04N 5/77; G06F 1/16

(52) U.S. Cl. CPC H04N 23/50; H04N 5/772; G06F 1/163

(57) ABSTRACT

Various embodiments include devices, systems, and methods for managing storage of video in response to an event in a body-worn video recording device. A body-worn video recording device may continuously store images captured by the camera in the rolling buffer memory, and copy images stored on the rolling buffer memory and storing images captured by the camera in a non-volatile memory in response to determining that a trigger event has occurred. A network computing device may receive from a first body-worn video recording device a signal that a trigger event has occurred, select one or more second body-worn video recording devices in response to receiving the signal that the trigger event has occurred, and send activation messages to the selected one or more second body-worn video recording devices to store images from a respective rolling buffer memory and subsequently captured images in a non-volatile memory.

### RELATED APPLICATIONS

This application claims the benefit of priority to U.S. Provisional Application No. 63/294,003 entitled “Methods and Systems for Managing Body-Worn Video Recording Devices” filed Dec. 27, 2021, the entire contents of which are incorporated herein by reference for all purposes.

### BACKGROUND

Body-worn recording video devices enable conveniently hands-free video and audio recordings of an activities and events. When used by law enforcement officials, body-worn video recording devices may gather evidence and provide a record of observations and activities. However, body-worn video recording devices have a limited battery life, and as a practical matter cannot operated continuously without exhausting their battery. For this reason, most body-worn video recording devices can be manually activated by a user. If the user is distracted or otherwise forgets to manually activate the body-worn video recording device, the device will not record potentially important evidence or events.

### SUMMARY

Various aspects disclosed herein include methods and systems for managing body-worn video recording devices. Various aspects may include a body-worn video recording device, including a camera, a rolling buffer memory coupled to the camera configured to continuously store a limited duration of images by overwriting stored images that are older than the limited duration, a wireless transceiver, a non-volatile memory, and a processor coupled to the camera, the rolling buffer memory, the wireless transceiver, and the non-volatile memory. In various aspects, the processor may be configured with processor-executable instructions to perform operations including continuously storing images captured by the camera in the rolling buffer memory, determining whether a trigger event has occurred, and copying images stored in the rolling buffer memory into the non-volatile memory and storing images captured by the camera in the non-volatile memory in response to determining that the trigger event has occurred.

In some aspects, the processor may be further configured with processor-executable instructions to perform operations such that storing images captured by the camera in the non-volatile memory may include storing images in the rolling buffer memory and then copying those images from the buffer memory to the non-volatile memory. In some aspects, the body-worn video recording device may further include a wireless sensor receiver coupled to the processor and configured to receive a signal from a holster sensor indicating that a weapon has been drawn from a holster, and the processor may be further configured with processor-executable instructions to perform operations such that determining whether a trigger event has occurred may include receiving a signal by the wireless sensor receiver and determining that the trigger event has occurred in response to the signal indicating that the weapon has been drawn from the holster.

In some aspects, the processor may be further configured with processor-executable instructions further including a panic button coupled to the processor. In such aspects, the processor may be further configured with processor-executable instructions to perform operations such that determining whether a trigger event has occurred may include receiving a signal from the panic button and determining that the trigger event has occurred in response to receiving the signal from the panic button.

In some aspects, the processor may be further configured with processor-executable instructions to perform operations such that determining whether a trigger event has occurred may include receiving an activation signal via the wireless transceiver, determining whether the activation signal includes an identifier corresponding to the body-worn video recording device, and determining that the trigger event has occurred in response to determining that the activation signal includes the identifier corresponding to the body-worn video recording device. In such aspects, the processor may be further configured with processor-executable instructions further including changing the identifier corresponding to the body-worn video recording device from time to time.

In some aspects, the processor may be further configured with processor-executable instructions to perform operations further including sending a trigger signal via the wireless transceiver to a second body-worn video recording device in response to determining that the trigger event has occurred. In such aspects, the trigger signal sent to the second body-worn video recording device may include a unique activation code associated with the second body-worn video recording device. In some aspects, the processor may be further configured with processor-executable instructions to perform operations further including changing the unique activation code associated with the second body-worn video recording device from time to time.

In some aspects, the processor may be further configured with processor-executable instructions to perform operations further including transmitting images captured by the camera to a network computing device in response to determining that the trigger event has occurred. In some aspects, the processor may be further configured with processor-executable instructions to perform operations such that transmitting images captured by the camera to a network computing device in response to determining that the trigger event has occurred may include sending to the network computing device an indication that the trigger event has occurred, receiving from the network computing device an instruction to transmit the images captured by the camera to the network computing device, and transmitting the images captured by the camera to the network computing device in response to the instruction from the network computing device.

Various aspects include methods of performing operations summarized above that may be implemented on a processor of a body-worn video recording device. Various aspects include a body-worn video recording device having means for performing functions summarized above. Various aspects include a non-transitory processor-readable storage medium having stored thereon processor-executable instructions configured to cause a processor of a body-worn video recording device to perform operations summarized above.

Various aspects disclosed herein include a network computing device, including a processor configured with processor-executable instructions to perform operations including receiving from a first body-worn video recording device a signal that a trigger event has occurred, selecting one or more second body-worn video recording devices in response to receiving the signal that the trigger event has occurred, and sending activation messages configure to cause the selected one or more second body-worn video recording devices to store images from a respective rolling buffer memory and subsequently captured images in a non-volatile memory.

In some aspects, the processor may be further configured with processor-executable instructions to perform operations such that selecting one or more second body-worn video recording devices in response to receiving the signal that the trigger event has occurred may include selecting one or more second body-worn video recording devices associated with a logical group of second body-worn video recording devices. In some aspects, the processor may be configured with processor-executable instructions further including receiving location information regarding the first body-worn video recording device and the one or more second body-worn video recording devices, wherein the processor may be further configured with processor-executable instructions to perform operations such that selecting one or more second body-worn video recording devices may include selecting the one or more second body-worn video recording devices based on location information regarding the first body-worn video recording device and the one or more second body-worn video recording devices.

In some aspects, the processor may be further configured with processor-executable instructions to perform operations such that selecting one or more second body-worn video recording devices based on location information regarding the first body-worn video recording device and the one or more second body-worn video recording devices may include selecting one or more second body-worn video recording devices that are within a threshold distance from the first body-worn video recording device. In some aspects, the processor may be further configured with processor-executable instructions to perform operations such that sending activation messages configured to cause the selected one or more second body-worn video recording devices to store images from a respective rolling buffer memory and subsequently captured images in a non-volatile memory may include sending activation messages configured to cause second body-worn video recording devices to store images from the respective rolling buffer memory and subsequently captured images in the non-volatile memory upon entering the threshold distance from the first body-worn video recording device, and sending deactivation messages to the second body-worn video recording devices to stop storing images upon leaving the threshold distance from the first body-worn video recording device.

In some aspects, the processor may be further configured with processor-executable instructions to perform operations such that selecting one or more second body-worn video recording devices in response to receiving the signal that the trigger event has occurred may include selecting one or more second body-worn video recording devices that are within a geofence area. In some aspects, the processor may be further configured with processor-executable instructions to perform operations such that sending activation messages to the selected one or more second body-worn video recording devices to store images from a respective rolling buffer memory and subsequently captured images in a non-volatile memory may include sending activation messages to second body-worn video recording devices to store images from a respective rolling buffer memory and subsequently captured images in a non-volatile memory upon entering the geofence area, and sending deactivation messages to the second body-worn video recording devices to stop storing images upon leaving the geofence area.

In some aspects, the processor may be further configured with processor-executable instructions to perform operations such that sending activation messages to the selected one or more second body-worn video recording devices to copy images from a respective rolling buffer memory and store subsequent captured images in a non-volatile memory may include sending activation messages to the selected one or more second body-worn video recording devices to copy images in the respective rolling buffer memory having a timestamp equal to or after a time value included in the activation messages. In some aspects, the processor may be further configured with processor-executable instructions to perform operations further including receiving from one or more of the first body-worn video recording device and the one or more second body-worn video recording devices images from a respective rolling buffer memory and subsequently captured images.

Various aspects include a network computing device having a processor configured with processor executable instructions to perform operations of any of the methods summarized above. Various aspects include a network computing device having means for performing functions of any of the methods summarized above. Various aspects include a non-transitory processor-readable storage medium having stored thereon processor-executable instructions configured to cause a processor of a network computing device to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a communication system according to various embodiments.

FIG. 2 is a component block diagram illustrating components of a body-worn video recording device element suitable for implementing various embodiments.

FIG. 3 is a component block diagram illustrating components of a network computing device suitable for implementing various embodiments.

FIG. 4 is a conceptual diagram illustrating aspects of a system configured to perform operations of a method for managing a body-worn video recording device according to various embodiments.

FIG. 5 is a conceptual diagram illustrating aspects of a system configured to perform operations of a method for managing a body-worn video recording device according to various embodiments.

FIG. 6 is a conceptual diagram illustrating aspects of a system configured to perform operations of a method for managing a body-worn video recording device according to various embodiments.

FIG. 7A is a process flow diagram illustrating a method for managing a body-worn video recording device according to various embodiments.

FIGS. 7B-7F are process flow diagrams illustrating operations that may be performed as part of the method for managing a body-worn video recording device according to various embodiments.

FIG. 8A is a process flow diagram illustrating a method for managing a body-worn video recording device according to various embodiments.

FIGS. 8B-8E are process flow diagrams illustrating operations that may be performed as part of the method for managing a body-worn video recording device according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Body-worn video recording devices are becoming standard equipment in many law enforcement communities. Recent cases have shown that body-worn video recording devices can record events involving police or other authorities actions that are helpful in understanding the circumstances of a complex event, providing video evidence that may be useful for trial and/or disciplinary proceedings.

Most body-worn video recording devices can be manually activated by a user. However, if the user is distracted or otherwise forgets to manually activate the body-worn video recording device, the device will not record potentially important evidence or events. This is especially the case for law enforcement officials, who may respond to or find themselves involved in a high-stress event or another situation that may distract them from manually activating a body-worn video recording device. Thus, body-worn video recording devices are sometimes not activated by users in time to record an event, if at all.

Automatic activation of body-worn video recording devices, such as in response to a weapon being drawn from its holster, may be useful features for such devices. However, automatic activation of body-worn video recording devices may fail to capture video of events leading up to whatever triggered the automatic activation, thus failing to show the context of an event. Recording of video during the entire shift of a police officer or other authority would overcome this limitation in body-worn video recording devices, but with the disadvantage of requiring non-volatile memory large enough to store eight or more hours of continuous video, which would drive up the cost of the devices.

Various embodiments provide body-worn video recording devices and methods of operating such devices that enable storing in non-volatile memory images (and in some cases audio) captured by a camera a period of time prior to and following a trigger event, thereby recording images for the period of time leading up to an event at which recording of images was triggered by a sensor or initiated by a signal (e.g., a user button press, reception of a signal from another device, reception of an activation message from a central control, etc.).

The term “body-worn video recording device” is used herein to refer to any electronic device that includes a camera, a programmable processor, a rolling buffer memory, and a non-volatile memory. The rolling buffer memory may be coupled to the camera and configured to continuously store a limited duration of images captured by the camera by overwriting stored images that are older than the limited duration (i.e., overwriting stored images that are older than the limited duration). A body-worn video recording device also may include a wireless transceiver and other components to enable wireless communication, such as with a cellular base station, wireless access point, and/or another body-worn video recording device. A body-worn video recording device also may include a sensor or wireless transceiver configured to receive signals from a sensor (e.g., a Bluetooth® transceiver), in which the sensor is configured to detect a condition indicative of an event that should be recorded (e.g., removal of a weapon from a holster). A body-worn video recording device also may include or be coupled to a fastener, clamp, adhesive, framework, or another device that enables the video recording device to be affixed to a user's clothing or to be worn by a user.

Various embodiments disclosed herein include devices, systems and methods for managing the recording of video images by such a body-worn video recording device. In some embodiments, a body-worn video recording device may continuously store images captured by a camera (and possibly audio) in a rolling buffer memory (for example, a Random Access Memory (RAM) or another volatile memory). The body-worn video recording device may determine whether a trigger event has occurred, such as in response to receiving a signal from a sensor (e.g., a holster sensor), a wireless signal from another recording device, and/or a message from a control center (e.g., via a wireless communication link). Until a trigger event is detected, the body-worn video recording device may continuously store images captured by the camera in the rolling buffer memory within a limited time by overwriting stored images that are older than the limited duration of video that can be stored in the buffer memory.

In response to determining that a trigger event has occurred, the body-worn video recording device may copy the limited duration of images stored on the rolling buffer memory to a non-volatile memory, as well as store images captured by the camera in the non-volatile memory. In some embodiments, the body-worn video recording device may store images in the rolling buffer memory and then copy those images from the buffer memory to the non-volatile memory. In some embodiments, after copying images stored on the rolling buffer memory to the non-volatile memory, the body-worn video recording device may store newly captured images in the non-volatile memory. In this manner, the non-volatile memory may store images that were captured by the camera during a period of time prior to the trigger event as well as images captured by the camera captured after the trigger event. Similarly, the non-volatile memory may store audio that was recorded by a microphone during a period of time prior to the trigger event as well as recording audio after the trigger event.

Some embodiments may be configured to receive a signal from a sensor in or coupled to a holster for a weapon, such as a handgun, or a Taser or other nonlethal weapon. In some embodiments, the body-worn video recording device may receive a signal from such a holster sensor indicating that the weapon has been drawn from the holster. In such embodiments, the body-worn video recording device may determine that a trigger event has occurred in response to receiving the signal indicating that the weapon has been drawn from the holster.

In some embodiments, the body-worn video recording device may include a button, an actuator or another suitable input device (e.g., a switch, a touch sensor, etc.), which is referred to herein as a “panic button,” that a user may press or actuate to manually initiate a trigger event (i.e., copy buffered image and audio data to the non-volatile memory and record subsequent images and audio to the non-volatile memory). In such embodiments, the body-worn video recording device may determine that a trigger event has occurred in response to a signal generated when the panic button is pressed.

In some embodiments, the body-worn video recording device may receive an activation signal via a wireless transceiver. In some embodiments, the activation signal may be sent by a network computing device. In some embodiments, the body-worn recording device may determine whether the activation signal includes an identifier, and determine that an event trigger has occurred if the identifier in the activation signal corresponds to the body-worn recording device. In some embodiments, the identifier may be uniquely associated with the body-worn recording device, such as a device serial number, a temporary unique number, a badge number of the user, etc. As a security measure, in some embodiments the body-worn video recording device may change the identifier from time to time.

In some embodiments, the body-worn video recording device may send a trigger signal via the wireless transceiver to one or more other (i.e., second) body-worn video recording devices in response to determining that a trigger event has occurred. For example, in response to determining that the trigger event has occurred the body-worn video recording device may broadcast the trigger signal that can be received by other body-worn video recording devices that are within reception range. In some embodiments, other body-worn video recording device(s) may recognize reception of the broadcast trigger signal as a trigger event, and begin to store record images to non-volatile memory, as well as copying images (and audio) to the non-volatile memory from a rolling buffer memory. In this manner, each body-worn video recording device within reception range may begin to capture and store images related to an event or occurrence first detected by the broadcasting body-worn video recording device. In some embodiments, the trigger event may include one or more unique activation codes associated with one or more other (i.e., second) body-worn video recording devices. In some embodiments, the body-worn video recording devices may be configured to change the unique activation code(s) from time to time.

In some embodiments, the body-worn video recording device may be configured to transmit via the wireless transceiver images, or a stream of images, captured by the camera to a network computing device. In some embodiments, the transmission of images captured by the camera to the network computing device may be initiated in response to determining that a trigger event has occurred. In some embodiments, the body-worn video recording device may send to the network computing device an indication that the trigger event has occurred. The body-worn video recording device may receive from the network computing device an instruction to transmit the images captured by the camera to the network computing device, and may transmit the images captured by the camera to the network computing device in response to the instruction from the network computing device.

For example, in some embodiments, a body-worn video recording device may execute or include a rule engine configured to determine whether a trigger event has occurred, and to copy images stored in the rolling buffer memory into the non-volatile memory and begin storing images captured by the camera in the non-volatile memory and/or to send a trigger signal via the wireless transceiver to a second body-worn video recording device in response to determining that the trigger event has occurred. In some embodiments, the body-worn video recording device may send an indication of the occurrence of the trigger event to a network computing device. In some embodiments, the network computing device may execute or include a rule engine configured to receive the indication of the occurrence of the trigger event and to determine whether to send a request or instruction to the body-worn video recording device, and/or to selected other body-worn video recording devices to transmit images captured by respective body-worn video recording device cameras to the network computing device.

In some embodiments, transmission of images from the body-worn video recording device(s) to the network computing device may be initiated or controlled by the network computing device. Configuring the network computing device to control the selection of and/or signaling to the body-worn video recording device(s) to transmit their images may enhance the scalability of the system. Further, configuring the network computing device to control the selection of and/or signaling to the body-worn video recording device(s) to transmit their images may enable the network computing device to manage and/or reduce being overloaded by incoming image transmissions from numerous body-worn video recording devices (which may be analogous to a denial of service attack). Such spikes in image transmissions to the network computing device also may substantially consume communication resources, such as communication links of a cellular or other wireless communication network, network transport bandwidth, and/or the like.

Various embodiments include methods performed by a network computing device for managing the storage of images (and audio) by body-worn video recording devices. In some embodiments, the network computing device may receive from a first body-worn video recording device a signal that a trigger event has occurred, and in response, select one or more second body-worn video recording devices that should begin storing images (and audio) in non-volatile memory. The network computing device may send activation messages to the selected one or more second body-worn video recording devices directing the device(s) to store data in their rolling buffer memory and subsequently captured images (and audio) in non-volatile memory. In some embodiments, the network computing device may select one or more second body-worn video recording devices associated with a logical group of second body-worn video recording devices. For example, two or more body worn video recording devices may be logically associated in a group, such as a team, a shift, a squad, a workgroup, or another logical association.

In some embodiments, the network computing device may receive location information from body-worn video recording devices, and use location information regarding the first and the one or more second body-worn video recording devices to select body-worn video recording devices that should receive the signal to store images from their rolling buffer memory and subsequently captured images to non-volatile memory. In some embodiments, the network computing device may select one or more second body-worn video recording devices that are within a threshold distance from the first body-worn video recording device. For example, the network computing device may select second body-worn video recording device(s) that are sufficiently close to first body-worn video recording device so as to be able to capture images that may be relevant to an event or occurrence being recorded by the first body-worn video recording device.

In some embodiments, the network computing device may select one or more second body-worn video recording devices that are within a defined or definable geographic area (referred to herein as a “geofence”). In some embodiments, the network computing device may send an activation message (i.e., a message indicating or that will be treated as a trigger event) to body-worn video recording devices that enter or leave the geofence area. In some embodiments, the network computing device may send activation message s to second body-worn video recording devices to store images from a respective rolling buffer memory and subsequently captured images in a non-volatile memory upon entering the geofence area. In some embodiments, the network computing device may send deactivation messages to the second body-worn video recording devices to stop storing images to non-volatile memory upon leaving the geofence area. For example, in a large-scale event or occurrence, first responder personnel (e.g., police, fire, emergency medical technicians, and the like) may be summoned from over a wide area. In such situations, the network computing device may determine or define a geofence area around the large-scale event or occurrence, and send activation message to body-worn video recording devices to begin saving images to the non-volatile memory upon entering the geofence area. Similarly, the network computing device may send deactivation messages to body-worn video recording devices to stop saving images to the non-volatile memory upon leaving the geofence area. In some embodiments, the network computing device may determine when body-worn video recording devices enter or leave the geofence area based on location information received from the devices. In some embodiments, the network computing device may define coordinate boundaries of the geofence area and send that information to body-worn video recording devices, which may use self-determined location information (e.g., coordinates determined from a GPS receiver) to recognize entry into or departure from the geofence area, and initiate or suspend recording of images (and audio) to non-volatile memory accordingly.

In some embodiments, the network computing device may include a timestamp or other specified time value in activation messages sent to selected body-worn video recording devices indicating a time from which stored images in the rolling buffer memory should be copied to non-volatile memory. In response to such activation messages, the selected body-worn video recording devices may copy images in their rolling buffer memory having a timestamp equal to or after the time value included in the activation message. For example, when a law enforcement officer draws a weapon from a holster and a holster sensor signals the law enforcement officer's (i.e., a first) body-worn video recording device, a processor in that device may determine that a trigger event has occurred, determine the time when the signal was received from the holster sensor, and signal the network computing device regarding the event including the determined time. In response, the network computing device may send activation messages to selected other body-worn video recording devices that include a time value based on the received determined time, instructing the selected (i.e., second) body-worn video recording devices to copy to non-volatile memory images in their respective rolling buffer memory having a timestamp equal to or after the time value. In some embodiments, the time value may be a time or time stamp that precedes the received determined time (i.e., time when the holster sensor activated) by a predetermined or selected duration (e.g., one minute, five minutes, etc.).

Various embodiments improve the operation of body-worn video recording devices by enabling the saving in nonvolatile memory of images that were continuously stored in volatile memory of a limited size (referred to herein as a rolling buffer memory) encompassing a limited duration prior to a trigger event. These innovations permit body-worn video recording devices to record events for a limited period of time prior to as well as after a triggering event, thereby recording events that may provide context of the trigger event, using non-volatile memory of a limited size. Various embodiments improve the operation of body-worn video recording devices while reducing device costs by enabling continuous operation of the camera for purposes of recording images (and audio) prior to recognition of an event requiring recording without requiring non-volatile memory to be large enough to store all images during a duty shift. Various embodiments improve the operation of body-worn video recording devices by enabling other (i.e., second) body-worn video recording devices to save images stored in volatile memory as well as subsequently captured images to a nonvolatile memory based on the trigger event, thereby storing images that may provide further context as well as a different perspective of an event.

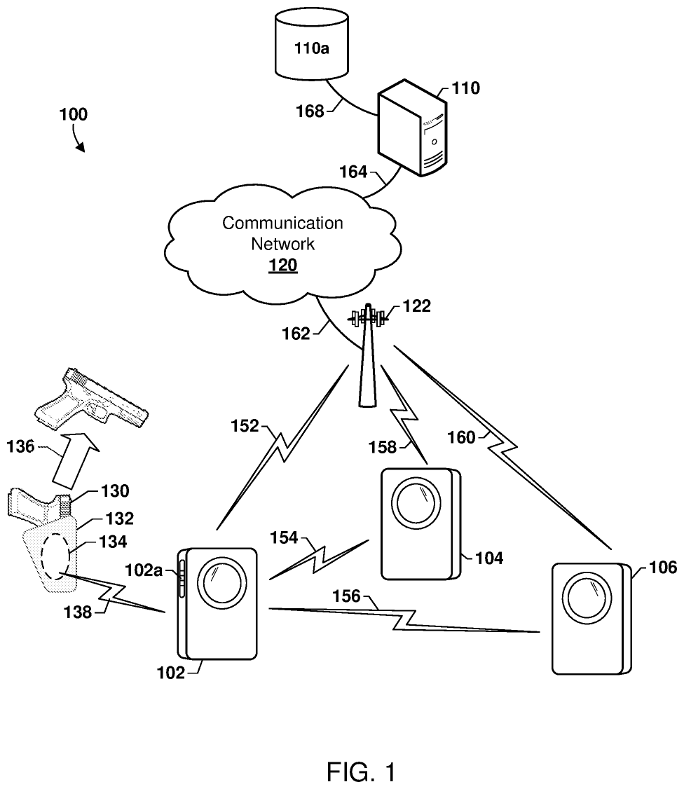

Various embodiments may be implemented within a system 100 of body-worn video recording devices, network computing devices and a communication system, an example of which is illustrated in FIG. 1. With reference to FIG. 1, the system 100 may include a first body-worn video recording device 102 and second body-worn video recording devices 104 and 106. The system 100 may include network elements such as a network computing device 110, and a communication network 120. The communication network 120 may include various network elements such as a base station 122 that may provide wireless access to the communication network 120 via a backhaul communication link 162. The network computing device 110 may communicate with the communication network 120 over a communication link 164. The network computing device 110 may communicate with a data store 110a via a wired or wireless communication link 168. In various embodiments, the operations of the network computing device 110 may be implemented in hardware, software, firmware, or any combination thereof. In some embodiments, the operations of the network computing device 110 may be implemented in software running on a virtual machine that is executing a on remote network computing device (e.g., cloud compute infrastructure).

The body-worn communication devices 102, 104, 106 may communicate with each other and with the base station 122 via wireless communication links 152-162. The first body-worn video recording device 102 may be configured to receive a signal 138 from a holster sensor 134 of a holster 132 configured to accommodate a weapon 130. In some embodiments, the signal 138 may indicate that the weapon 130 has been removed 136 from the holster 132. In some embodiments, the first body-worn video recording device 102 may be configured to receive a signal from a panic button 102a, which in some embodiments may be supported by the first body-worn video recording device 102, or may be remote from configured to communicate over a wired or wireless communication link with the first body-worn video recording device 102.

The communication network 120 may support wired and/or wireless communication among the body-worn video recording devices 102, 104, 106, and the network computing device 110. The communication network 120 may include one or more additional network elements, such as servers and other similar devices (not shown). The communication system 100 may include additional network elements to facilitate communication among the body-worn video recording devices 102, 104, 106, and the network computing device 110. The communication links 162, 164, and 168 may include wired and/or wireless communication links. Wired communication links may include coaxial cable, optical fiber, and other similar communication links, including combinations thereof (for example, in a hybrid fiber coaxial (HFC) network). Wireless communication links may include a plurality of carrier signals, frequencies, or frequency bands, each of which may include a plurality of logical channels. Wired communication protocols may use a variety of wired networks (e.g., Ethernet, TV cable, telephony, fiber optic and other forms of physical network connections) that may use one or more wired communication protocols, such as Data Over Cable Service Interface Specification (DOCSIS), Ethernet, Point-To-Point protocol, High-Level Data Link Control (HDLC), Advanced Data Communication Control Protocol (ADCCP), and Transmission Control Protocol/Internet Protocol (TCP/IP), or another suitable wired communication protocol.

The wireless communication links 152-160 may include a plurality of carrier signals, frequencies, or frequency bands, each of which may include a plurality of logical channels. Each of the wireless communication links may utilize one or more radio access technologies (RATs). Examples of RATs that may be used in one or more of the various wireless communication links 152-160 include any of the Institute of Electrical and Electronics Engineers (IEEE) 802.11 standards (e.g., Wi-Fi), the Bluetooth standard, Bluetooth Low Energy (BLE), an IEEE 802.15.4 protocol (such as Thread, ZigBee, and Z-Wave), any of the Institute of Electrical and Electronics Engineers (IEEE) 16.11 standards, 6LoWPAN, LTE Machine-Type Communication (LTE MTC), Narrow Band LTE (NB-LTE), Cellular IoT (CIoT), Narrow Band IoT (NB-IoT), BT Smart, Wi-Fi, LTE-U, LTE-Direct, MuLTEfire, as well as relatively extended-range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), and Weightless. Further examples of RATs that may be used in one or more of the various wireless communication links within the communication system 100 include any 3G, 4G, 5G, 6G standard and/or the like, such as 3GPP Long Term Evolution (LTE), Global System for Mobility (GSM), GSM/General Packet Radio Service (GPRS), Enhanced Data GSM Environment (EDGE), Code Division Multiple Access (CDMA), frequency division multiple access (FDMA), time division multiple access (TDMA), Wideband Code Division Multiple Access (W-CDMA), Worldwide Interoperability for Microwave Access (WiMAX), Time Division Multiple Access (TDMA), and other mobile telephony communication technologies cellular RATs, Terrestrial Trunked Radio (TETRA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, and other mobile telephony communication technologies cellular RATs or other signals that are used to communicate within a wireless or cellular network or further implementations thereof.

In some embodiments, the body-worn communication devices 102, 104, 106 and/or the network computing device 110 may be configured to use one or more RATs preferentially or in a preferred hierarchy, such as by default, or based on a dynamic determination such as based on a highest signal strength, a best-available bandwidth, data carriage capacity, available modulation and coding schemes, and/or another suitable metric or determination. For example, the body-worn communication devices 102, 104, 106 and/or the network computing device 110 may be configured to use a cellular communication link as a first option, a Wi-Fi communication link as a second option, and/or another suitable RAT or communication link as another option.

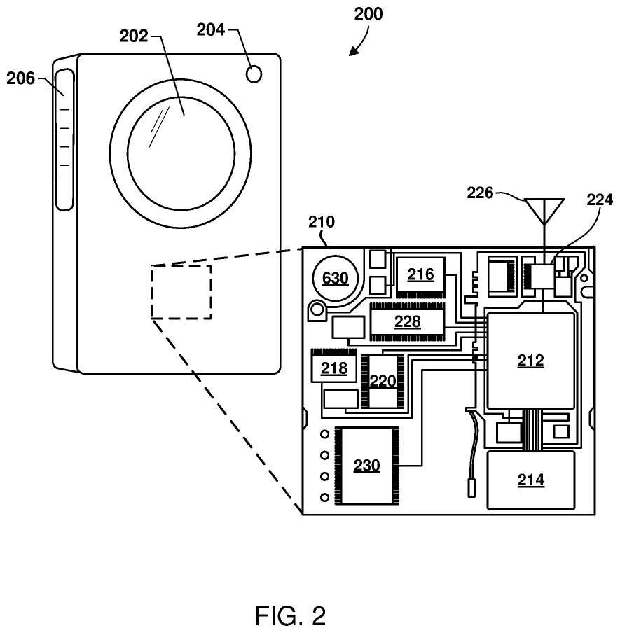

FIG. 2 is a component block diagram of a body-worn video recording device 200 suitable for use with various embodiments. With reference to FIGS. 1 and 2, the body-worn video recording device 200 (e.g., 102, 104, 106) may include a camera 202 configured to capture images and/or video, and a microphone 204 configured to capture sound. The body-worn video recording device 200 may include a panic button 206 or another suitable input device. In some embodiments the panic button 206 may be incorporated into or supported by the body-worn video recording device 200. In some embodiments, the panic button 206 may be remote from configured to communicate over a wired or wireless communication link with the body-worn video recording device 200. The body-worn video recording device 200 may include a processing system 210. The processing system 210 may include one or more system-on-chip (SOC) devices 212, 214 that may include one or more processors any of which may be configured with processor-executable instructions to perform operations of various embodiments.

The SOCs 212, 214 may be coupled to interface circuitry 216 configured to control and receive data from the camera 202 and the microphone 204 and a signal from the panic button 206. The SOCs 212, 214 may be coupled to volatile memory 218 that may be configured to include or operate as a rolling buffer memory, non-volatile memory 220, and communication circuitry 224 coupled to one or more antenna 226 configured to send or receive wireless signals (e.g., to or from a second body-worn video recording device (e.g., 104, 106), a base station (e.g., 122), or a holster sensor 134 or another suitable device). The SOCs 212, 214 also may be coupled to a location device 228 such as an inertial measurement unit (IMU) that includes electronic gyroscopes, accelerometers, and a magnetic compass, a Global Positioning System (GPS) receiver (which may receive GPS signals via the communication circuitry 224), or another suitable device by which the body-worn video recording device 200 may obtain location information. The body-worn video recording device 200 may further include a power source such as a rechargeable battery 230 coupled to the SOCs 202, 204 and other components. The body-worn video recording device 200 also may include or be coupled to a fastener, clamp, adhesive, framework, or another device (not illustrated) that enables the video recording device to be affixed to a user's clothing or to be worn by a user.

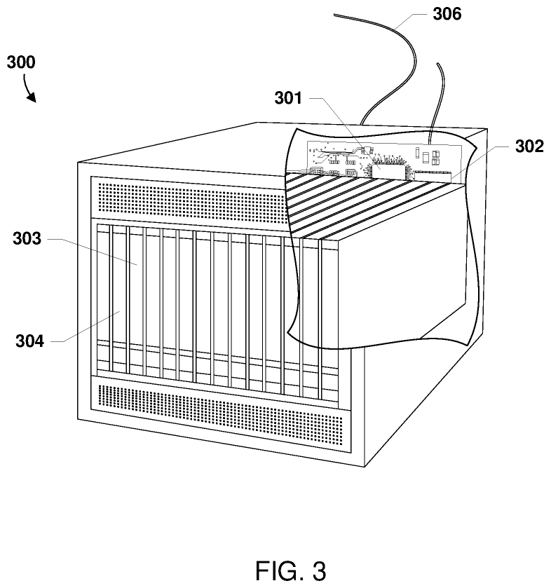

FIG. 3 is a component block diagram of a network computing device 300 suitable for use with various embodiments. With reference to FIGS. 1-3, the network computing device 300 (e.g., the computing device 110) may include a processor 301 coupled to volatile memory 302 and a large capacity nonvolatile memory, such as a disk drive 303. The network computing device 300 may also include a peripheral memory access device such as a floppy disc drive, compact disc (CD) or digital video disc (DVD) drive 304 coupled to the processor 301. The network computing device 300 may also include network access ports 306 (or interfaces) coupled to the processor 301 for establishing data connections with a network, such as the Internet and/or a local area network coupled to other system computers and servers. Similarly, the network computing device 300 may include additional access ports, such as USB, Firewire, Thunderbolt, and the like for coupling to peripherals, external memory, or other devices.

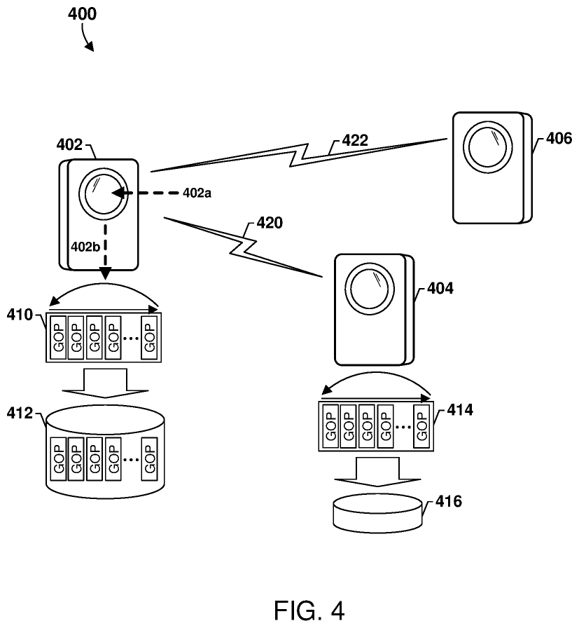

FIG. 4 is a conceptual diagram illustrating aspects of a system 400 configured to perform operations of a method for managing a body-worn video recording device according to various embodiments. With reference to FIGS. 1-4, the operations of body-worn video recording devices 402, 404, and 406 (e.g., 102, 104, 106, 200) may be implemented in hardware components and/or software components, the operation of which may be controlled by one or more processors (e.g., the processors 212, 214, and and/or the like), referred to herein as a “processor.”

In various embodiments, the body-worn recording device 402 may capture images 402a, and may continuously store a limited duration worth of images 402b in a volatile rolling buffer memory 410. In some embodiments, the limited duration may be a period of minutes to an hour, but in various embodiments, the duration may vary based on available memory storage and the size and/or structure of the images or video stored. In some embodiments, the rolling buffer memory 410 may include dynamically allocated RAM of the body-worn recording device 402.

The body-worn recording device 402 may store the images 402b in any of a variety of digital formats. In some embodiments, the body-worn recording device 402 may store the images 402b as a Group of Pictures (GOP). Each GOP may include image block, video blocks, audio blocks, metadata blocks, or other information. In some embodiments, a GOP structure may include a sequence in which frames are placed within a stream of images or video. The GOP structure may include intra-coded frames (I-frames), predictive coded frames (P-frames), and bi-directionally predictive coded frames (B-frames). In some embodiments, each GOP structure may begin with an I-frame that includes an image of a complete scene that is used as the reference frame in the structure. P-frames may record data changes that are different than the previous frame, which may allow the body-worn recording device 402 to save memory space since the data of the I-frame is not duplicated. B-frames may capture data changes from the previous frame, and also may capture the data changes from the frame after the B-frame. In some embodiments, each GOP may include metadata associated with images or video. Such metadata may include a timestamp of an image or video. Such metadata also may include sequencing information to enable proper decoding and/or playback of images or video. The size of each GOP may vary based on the amount of data stored in each GOP. In some embodiments, the body-worn recording device 402 may limit the size and/or the duration of a GOP.

In some embodiments, the body-worn recording device 402 may determine whether a trigger event has occurred. In response to determining that the trigger event has occurred the body-worn recording device 402 may copy images (e.g., the GOPs) stored in the rolling buffer memory 410 to a nonvolatile memory 412. In various embodiments, the trigger event may include receiving a signal indicating that the weapon has been drawn from a holster, receiving a signal indicating that the panic button has been pressed, receiving an activation signal 420 via a wireless transceiver (e.g., 224, 226), receiving an activation message from a network computing device via a wireless transceiver (e.g., 224, 226), or another suitable trigger event. In some embodiments, subsequent images may be stored, or GOPs may be constructed, in the rolling buffer memory 410, and then copied to the nonvolatile memory 412. In some embodiments, assessment images or GOPs may be stored directly in the nonvolatile memory.

In some embodiments, the body-worn recording device 402 may send a trigger signal 420 via the wireless transceiver (e.g., 224, 226) to a second body-worn video recording device 404 in response to determining that the trigger event has occurred. In some embodiments, the trigger signal may include a unique activation code associated with the second body-worn video recording device 404. For example, each body-worn recording device 402, 404, 406 may be associated with or configured to recognize a unique activation code. In some embodiments, each body-worn recording device 402, 404, 406 may be configured to begin copying images stored in a respective rolling buffer memory of each body-worn recording device 402, 404, 406 into a nonvolatile memory in response to receiving a signal including that device's unique activation code. In some embodiments, in response to determining that the trigger event has occurred, the body-worn recording device 402 may send the trigger signal 420 via a wireless signal, such as a short range, medium range, and/or long range wireless signal (such as Bluetooth, Wi-Fi, a cellular signal, or any other suitable wireless signal) to the second body-worn video recording device 404.

In response to receiving the trigger signal and determining that the received trigger signal includes its unique activation code, the second body-worn video recording device 404 may begin copying images stored in a rolling buffer memory 414 into a nonvolatile memory 416. In contrast, a third body-worn video recording device 406 may receive a trigger signal 422 from the body-worn recording device 402, but the third body-worn video recording device 406 may determine that the trigger signal 422 does not include the unique activation code of the third body-worn video recording device 406. In response to determining that the trigger signal 422 does not include its unique activation code, the third body-worn video recording device 406 may not copy images stored in its rolling buffer memory to a non-volatile memory (not illustrated).

In some embodiments, each body-worn video recording device 402, 404, 406 may be configured to change its unique activation code from time to time. For example, each body-worn video recording device 402, 404, 406 may deterministically rotate its respective unique activation code. Changing unique activation codes from time to time may mitigate replay attacks or similar attacks against a body-worn video recording device. In some embodiments, a body-worn video recording device may use the presence of its unique activation code to validate the received signal. In some embodiments, a body-worn video recording device may use its activation code as a seed for a time-based password generator. In some embodiments, a processor of the body-worn video recording device may use a seed that is known to both the body-worn video recording device and to the network computing device as an input to an algorithm for generating activation codes that is used by both the body-worn video recording device and to the network computing device to generate a new unique activation code. Any of a variety of algorithms may be used to generate the new unique activation code, such as a pseudorandom number generator. In some embodiments, both the body-worn video recording device and the network computing run the common algorithm to generate the new unique activation code at approximately the same time. That way, when the network computing device sends an activation message, the addressed body-worn video recording device will recognize its unique activation code, and respond by activating the recording of buffered and subsequently captured images to the non-volatile memory as described.

In some embodiments, a clock, timer, or another time sensing device of each body-worn recording device 402, 404, 406 may be synchronized, such as with a clock of a network computing device, thereby ensuring that all devices have synchronized clocks. For example, the body-worn recording devices 402, 404, 406 may be synchronized when the devices are docked to charge their respective batteries. In some embodiments, timestamps associated with images or video and based on each body-worn recording device's internal clock or timer may be used to obtain images or video of an event or occurrence from the multiple viewpoints of each of the body-worn recording devices.

In some embodiments, a configuration file may be sent to or provided to each body-worn video recording device 402, 404, 406. Such a configuration file may include, for example, parameters such as image or video recording dimensions, a frame rate, a streaming configuration, a bit rate, input button configuration information, trigger event configuration information, a unique activation code, and/or other suitable information. In some embodiments, each body-worn video recording device 402, 404, 406 may be associated with an individual user, and such association may be stored in metadata, for example, associated with recorded images or video.

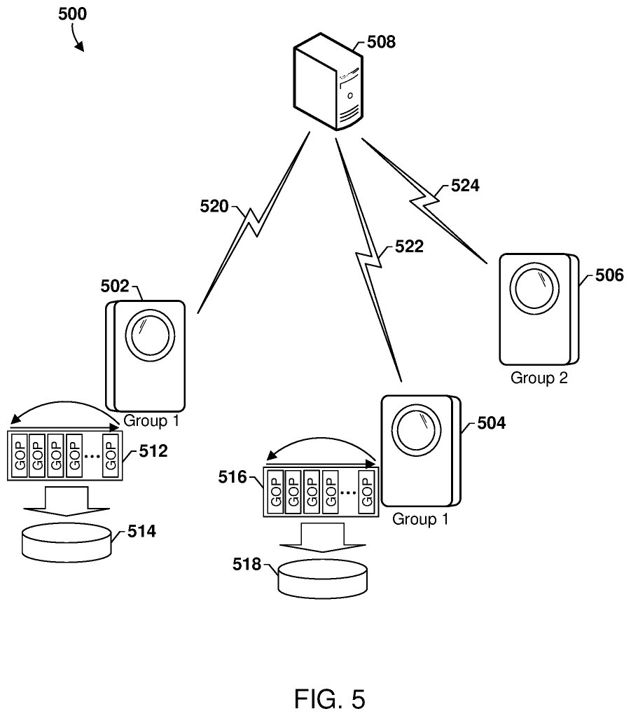

FIG. 5 is a conceptual diagram illustrating aspects of a system 500 configured to perform operations of a method for managing a body-worn video recording device according to various embodiments. With reference to FIGS. 1-5, the operations of body-worn video recording devices 502, 504, and 506 (e.g., 102, 104, 106, 200) and a network computing device 508 (e.g., 110, 300) may be implemented in hardware components and/or software components, the operation of which may be controlled by one or more processors (e.g., the processors 212, 214, 301, and/or the like), referred to herein as a “processor.”

In some embodiments, the network computing device 508 may receive from the first body-worn video recording device 502 a signal that a trigger event has occurred via a communication link 520. As noted above, in response to determining that the trigger event has occurred, the first body-worn video recording device 502 may copy images stored in the rolling buffer memory 512 and store images captured by the camera in a non-volatile memory 514. In response to receiving the signal that the trigger event has occurred, the network computing device 508 may select one or more second body-worn video recording devices. In some embodiments, the network computing device 508 may select one or more second body-worn video recording devices associated with a logical group of second body-worn video recording devices. For example, the network computing device 508 may determine that the first body-worn video recording device 502 is associated with a first logical group (e.g., “Group 1”). The network computing device 508 may determine that the second body-worn video recording device 504 is also associated with the first logical group, select the second body-worn video recording device 504 in response to determining that the second body-worn video recording device 504 is associated with the first logical group. In some embodiments, the network computing device may determine that the third body-worn video recording device 506 is associated with a second logical group (e.g., “Group 2”). In response to determining that the third body-worn video recording device 506 is associated with a second logical group, the network computing device 508 may not select the third body-worn video recording device 506.

The network computing device 508 may send a signal via a communication link 522 to the second body-worn video recording device 504 to store images from its respective rolling buffer memory 516 and subsequently captured images in a non-volatile memory 518. In this manner, the network computing device 508 may send activation messages to body-worn recording devices within a logical group (or groups) to begin storing images from the rolling buffer memory (e.g., 516) and subsequently captured images in the non-volatile memory (e.g., 518). In some embodiments, the network computing device 508 may associate each body-worn video recording device with a logical group when configuring (sending or providing configuration information) to each body-worn video recording device. In some embodiments, the network computing device 508 may dynamically adjust an association of a body-worn video recording device to a different logical group (or groups).

In some embodiments, the network computing device 508 may include in the activation message to the second body-worn video recording device(s) a time value or time stamp. In such embodiments, the network computing device 508 may send activation messages to the selected one or more second body-worn video recording devices to copy images in the respective rolling buffer memory having a timestamp equal to or after a time value included in the activation messages. For example, the network computing device 508 may receive an activation message from the first body-worn video recording device 502 that a trigger event has occurred. The signal from the first body-worn video recording device 502 may be associated with a time value. In such embodiments, the network computing device 508 may include in the activation messages sent to the selected one or more second body-worn video recording devices the time value received from the first body-worn video recording device 502, or a time value based on the time value received from the first body-worn video recording device 502. In response to receiving the activation message from the network computing device 508 including the time value, the second body-worn video recording device(s) may begin to copy images in their respective rolling buffer memory having a timestamp equal to or after the time value included in the activation messages. In this manner, all receiving second body-worn video recording devices may begin saving images or video from substantially the same timestamp.

In some embodiments, in addition to, or as an alternative to, storing images from a respective rolling buffer memory and subsequently captured images in a non-volatile memory, one or more of the body-worn video recording devices 502, 504, 506 may be configured to transmit images, or a stream of images, to the network computing device 508 via separate communication links 520, 522, 524. In some embodiments, the network computing device 508 may receive images or video from one or more of the body-worn video recording devices 502, 504, 506, and may present such images or video for user. For example, a network operations center or dispatch center may include the network computing device 508, and images or video from one or more of the body-worn video recording devices 502, 504, 506 may be presented for operations personnel for review in real-time or near real-time.

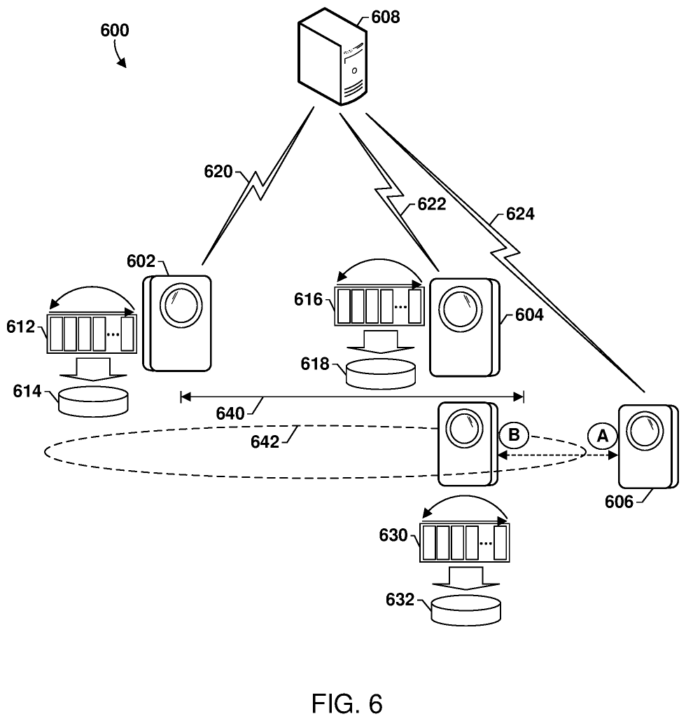

FIG. 6 is a conceptual diagram illustrating aspects of a system 600 configured to perform operations of a method for managing a body-worn video recording device according to various embodiments. With reference to FIGS. 1-6, the operations of body-worn video recording devices 602, 604, and 606 (e.g., 102, 104, 106, 200) and a network computing device 608 (e.g., 110, 300) may be implemented in hardware components and/or software components, the operation of which may be controlled by one or more processors (e.g., the processors 212, 214, 301, and/or the like), referred to herein as a “processor.”

In some embodiments, the network computing device 608 may receive from the first body-worn video recording device 602 a signal that a trigger event has occurred via a communication link 620. As noted above, in response to determining that the trigger event has occurred, the first body-worn video recording device 602 may copy images stored in the rolling buffer memory 612 into a non-volatile memory 614 and store images captured by the camera in the non-volatile memory 614. In response to receiving the signal that the trigger event has occurred, the network computing device 608 may select one or more second body-worn video recording devices. In some embodiments, the network computing device 608 may select the one or more second body-worn video recording devices based on location information related to the first body-worn video recording device 602 and location information related to the one or more second body-worn video recording devices.

In some embodiments, the network computing device 608 may select one or more second body-worn video recording devices that are within a threshold distance 640 from the first body-worn video recording device 602. For example, the network computing device 608 may determine that the second body-worn video recording device 604 is within the threshold distance 640 from the first body-worn video recording device 602. As another example, the network computing device 608 may determine that the second body-worn video recording device 604 is within a geofence area 642. In this manner, the network computing device 608 may select second body-worn video recording devices that are, for example, reasonably likely to capture images or video of a specific location, or of a particular event or occurrence. The network computing device 608 may send an activation message 622 to the selected one or more second body-worn video recording devices (e.g., 604) to store images from a respective rolling buffer memory 616 and subsequently captured images in a non-volatile memory 618.

In some embodiments, the network computing device 608 may determine both a location of the second body-worn video recording devices and a logical grouping of the second body-worn video recording devices. For example, the network computing device 608 may determine that the first body-worn video recording device 602 and the second body-worn video recording devices 604 and 606 are associated with the same logical grouping. The network computing device 608 may determine that the second body-worn video recording device 604 is within the threshold distance 640 or the geofence area 642, and may select the body-worn video recording device 604. In contrast, the network computing device 608 may determine that the second body-worn video recording device 606 at location A, and is not within the threshold distance 640 or the geofence area 642, and so the network computing device 608 may not select the body-worn video recording device 606 at location A.

In some embodiments, the network computing device 608 may select a second body-worn video recording device 606 that enters the threshold distance 640 from the first body-worn video recording device 602 or enters the geofence area 642. For example, first responder personnel equipped with body-worn video recording devices may be summoned from over a wide area in the event of a large-scale event or occurrence. However, images or video relevant to the large-scale event may only be obtained in or near the location of the event or occurrence. In such cases, the network computing device 608 may determine a threshold distance 640 from the first body-worn video recording device 640, or the geofence area 642, and send an activation message to body-worn video recording devices that enter the threshold distance 640 or the geofence area 642 to store images from their respective rolling buffer memorys 630 and subsequently captured images in a non-volatile memory 632. For example, the network computing device may determine that the second body-worn video recording device 606 at location B has entered the threshold distance 640 or the geofence area 642, and may send an activation message via the communication link 624 to the second body-worn video recording device 606 to store images from its rolling buffer memory 630 and subsequently captured images in the non-volatile memory 632. Similarly, the network computing device may determine that the second body-worn video recording device 606 has moved from location B to location A, and thus has left the threshold distance 640 or the geofence area 642. In response to determining that the second body-worn video recording device 606 has left the threshold distance 640 or the geofence area, the network computing device 608 may send a deactivation message via the communication link 624 to the second body-worn video recording device 606 to stop storing images in the nonvolatile memory 632.

In some embodiments, in addition to, or as an alternative to, storing images from a respective rolling buffer memory and subsequently captured images in a non-volatile memory, one or more of the body-worn video recording devices 602, 604, 606 may be configured to transmit images, or a stream of images, to the network computing device 608. In some embodiments, the network computing device 608 may receive images or video from one or more of the body-worn video recording devices 602, 604, 606, and may present such images or video for user. For example, a network operations center or dispatch center may include the network computing device 608, and images or video from one or more of the body-worn video recording devices 602, 604, 606 may be presented for operations personnel for review in real-time or near real-time.

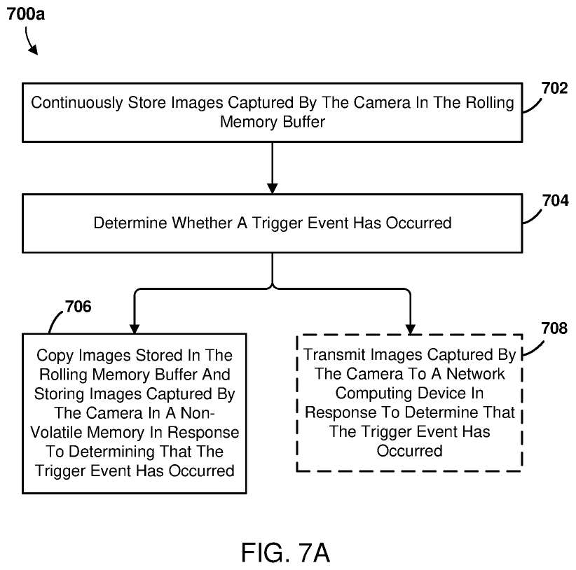

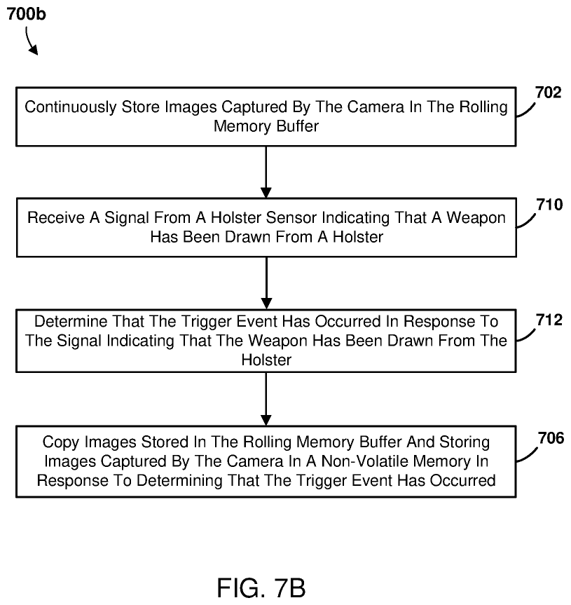

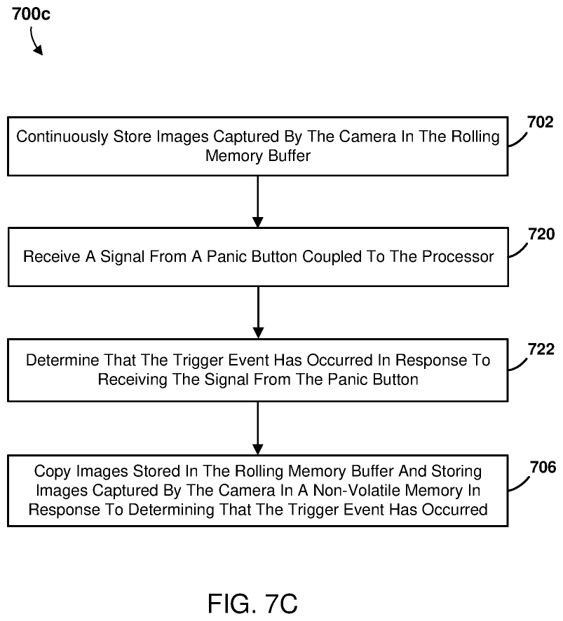

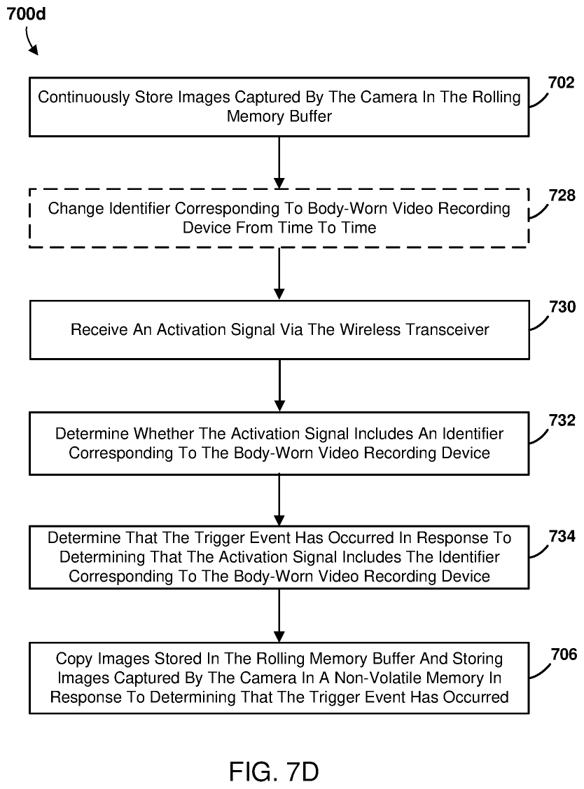

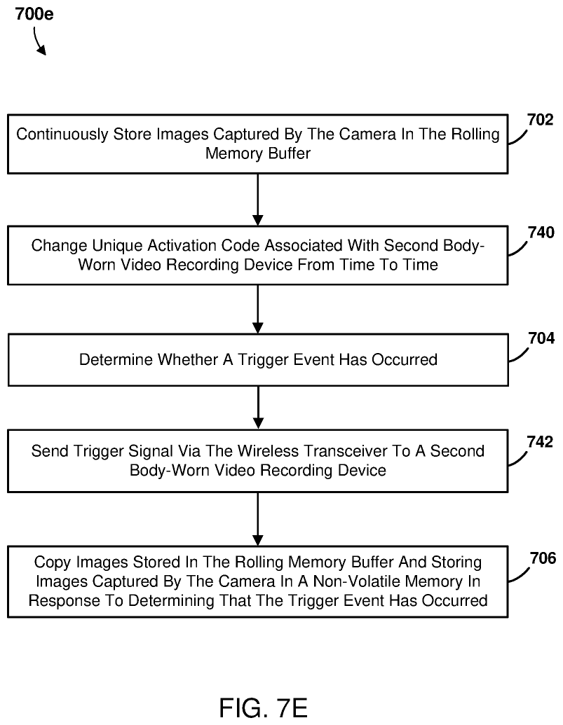

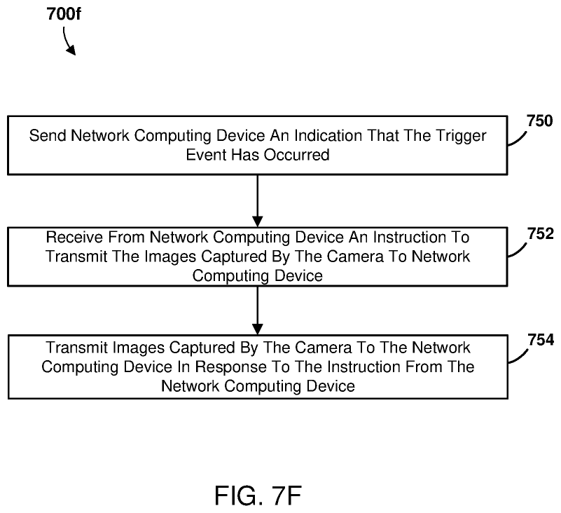

FIG. 7A is a process flow diagram illustrating a method 700a for managing a body-worn video recording device according to various embodiments. With reference to FIGS. 1-7A, the operations of the method 700a may be implemented in hardware components and/or software components of a body-worn video recording device (e.g., 102, 104, 106, 200, 402, 404, 406, 502, 504, 506, 602, 604, 606), the operation of which may be controlled by one or more processors (e.g., the processors 212, 214, 301, and/or the like), referred to herein as a “processor.”

In block 702, the processor may continuously store images captured by a camera of the body-worn video recording device in a rolling buffer memory of the body-worn video recording device. For example, the processor may store images 402a in a rolling buffer memory 410, 512, 612. In some embodiments, the rolling buffer memory may store a limited duration of images or video by overwriting stored images that are older than the limited duration (i.e., overwriting images that have been stored in the buffer memory longer than the limited duration).

In block 704, the processor may determine whether a trigger event has occurred. For example, the trigger event may include receiving a signal indicating that the weapon has been drawn from a holster, receiving a signal indicating that the panic button has been pressed, receiving an activation signal from another body-worn video recording device via a wireless transceiver, receiving an activation message from a network computing device, or another suitable trigger event.

In block 706, the processor may copy images stored in the rolling buffer memory and storing images captured by the camera in a non-volatile memory in response to determining that the trigger event has occurred. In some embodiments, storing images captured by the camera in the non-volatile memory may include storing images in the rolling buffer memory and then copying those images from the buffer memory to the non-volatile memory. In some embodiments, the body-worn video recording device may store images in the rolling buffer memory and then copy those images from the buffer memory to the non-volatile memory. In some embodiments, after copying images stored on the rolling buffer memory to the non-volatile memory, the body-worn video recording device may store newly captured images in the non-volatile memory.

In optional block 708, the processor may transmit images captured by the camera to a network computing device in response to determining that the trigger event has occurred.

FIGS. 7B-7F are process flow diagrams illustrating operations 700b-700f that may be performed as part of the method 700a for managing a body-worn video recording device according to various embodiments. With reference to FIGS. 1-7F, the operations 700b-700f may be implemented in hardware components and/or software components of a body-worn video recording device (e.g., 102, 104, 106, 200, 402, 404, 406, 502, 504, 506, 602, 604, 606), the operation of which may be controlled by one or more processors (e.g., the processors 212, 214, 301, and/or the like), referred to herein as a “processor.”

Referring to FIG. 7B, while continuously store images captured by a camera of the body-worn video recording device in a rolling buffer memory of the body-worn video recording device in block 702 as described, the processor may receive a signal from a holster sensor indicating that a weapon has been drawn from a holster in block 710. For example, the processor may receive a signal from the holster sensor 134 indicating that the weapon 130 has been drawn from the holster 132.

In block 712, the processor may determine that the trigger event has occurred in response to the signal indicating that the weapon has been drawn from the holster.

The processor may copy images stored in the rolling buffer memory and storing images captured by the camera in a non-volatile memory in response to determining that the trigger event has occurred in block 706 as described.

Referring to FIG. 7C, while continuously store images captured by a camera of the body-worn video recording device in a rolling buffer memory of the body-worn video recording device in block 702 as described, the processor may receive a signal from a panic button coupled to the processor, e.g., indicating that the panic button has been pressed or activated in a suitable manner in block 720. For example, the processor may receive a signal from the panic button 102a indicating that the panic button 102a has been pressed (i.e., activated).

In block 722, the processor may determine that the trigger event has occurred in response to the signal from the panic button.

The processor may copy images stored in the rolling buffer memory and storing images captured by the camera in a non-volatile memory in response to determining that the trigger event has occurred in block 706 as described.

Referring to FIG. 7D, while continuously store images captured by a camera of the body-worn video recording device in a rolling buffer memory of the body-worn video recording device in block 702 as described, the processor may change an identifier corresponding to the body-worn video recording device from time to time in block 728.

In block 730, the processor may receive via the wireless transceiver an activation signal from another body-worn video recording device, or an activation message from a network computing device. For example, the processor may receive an activation signal from another body-worn video recording device 104, 106, 404, 406, 504, 506, 604, 606, or an activation message from the network computing device 110, 300, 508, 608.

In block 732, the processor may determine whether the activation signal includes an identifier corresponding to the body-worn video recording device.

In block 734, the processor may determine that the trigger event has occurred in response to determining that the activation signal includes the identifier corresponding to the body-worn video recording device.

The processor may copy images stored in the rolling buffer memory and storing images captured by the camera in a non-volatile memory in response to determining that the trigger event has occurred in block 706 as described.

Referring to FIG. 7E, while continuously storing images captured by a camera of the body-worn video recording device in a rolling buffer memory of the body-worn video recording device in block 702 as described, the processor may change a unique activation code associated with a second body-worn video recording device from time to time in block 740.

In block 704, the processor may determine whether a trigger event has occurred as described.

In block 742, the processor may send a trigger signal via the wireless transceiver to a second body-worn video recording device in response to determining that the trigger event has occurred. In some embodiments, the processor may configure the trigger signal to include a unique activation code associated with the second body-worn video recording device.

The processor may copy images stored in the rolling buffer memory and storing images captured by the camera in a non-volatile memory in response to determining that the trigger event has occurred in block 706 as described.

Referring to FIG. 7F, the operations 700f are an example of operations that may be performed as part of transmitting images captured by the camera to a network computing device in response to determining that the trigger event has occurred in optional block 708 (FIG. 7A).

In block 750, the processor may send to the network computing device an indication that the trigger event has occurred. For example, the processor may send a message via a wireless (e.g., cellular) communication link addressed to the network computing device.

In block 752, the processor may receive from the network computing device an instruction to transmit the images captured by the camera to a network computing device. For example, the processor may receive a message via the wireless (e.g., cellular) communication link with the network computing device.

In block 754, the processor may transmit the images captured by the camera to the network computing device in response to the instruction from the network computing device. For example, the processor may send image data via a wireless (e.g., cellular) communication link in packets addressed to the network computing device.

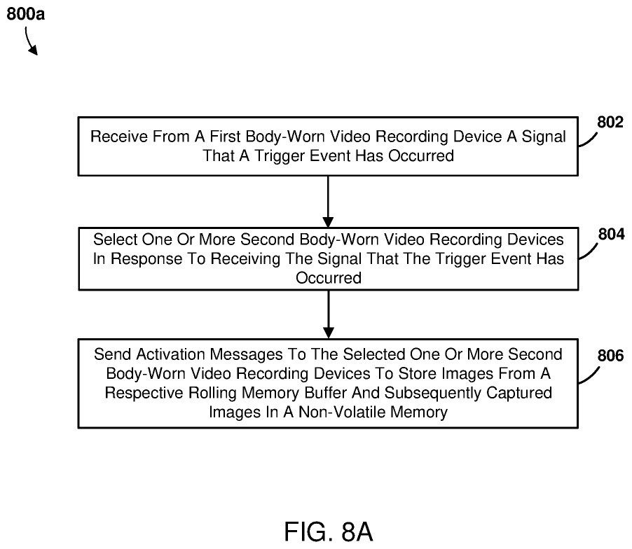

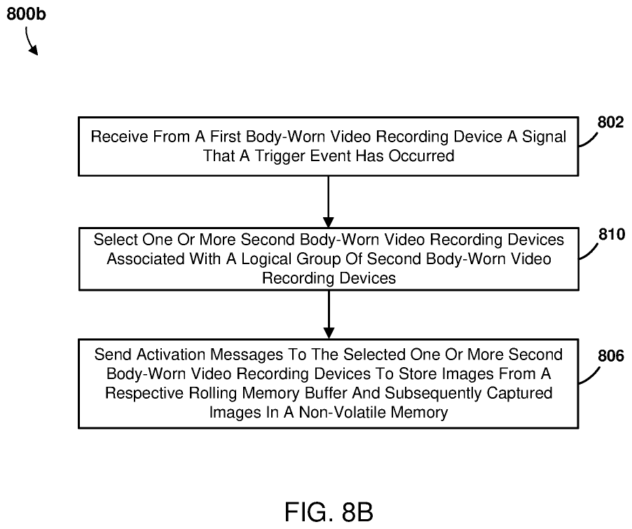

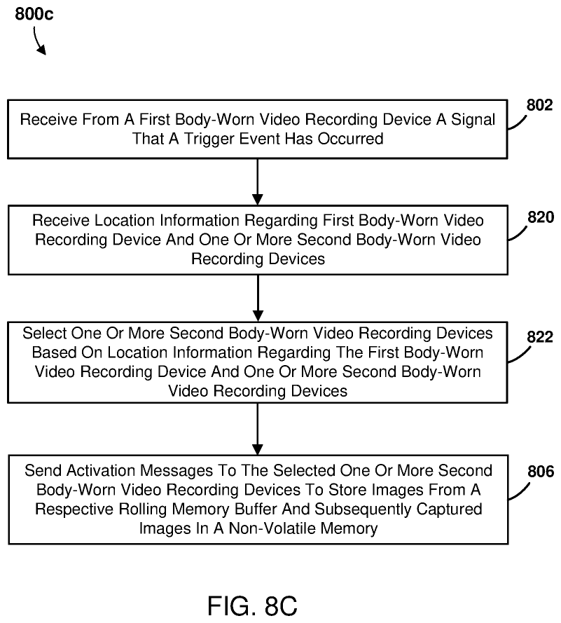

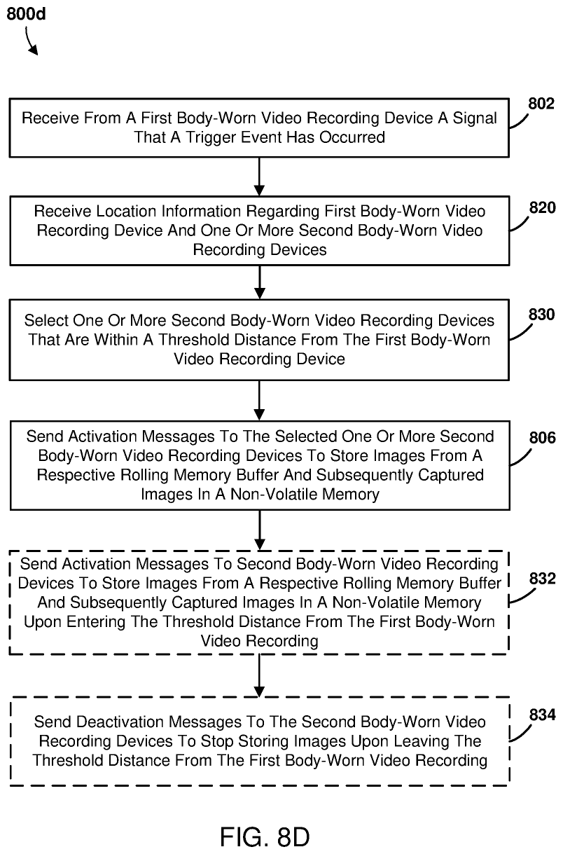

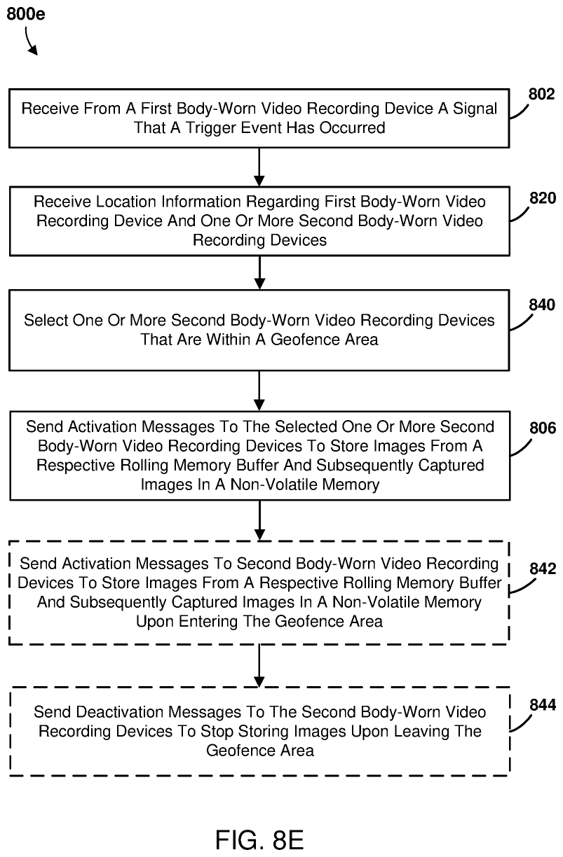

FIG. 8A is a process flow diagram illustrating a method 800a for managing a body-worn video recording device according to various embodiments. With reference to FIGS. 1-8A, the operations of the method 800a may be implemented in hardware components and/or software components of a network computing device (e.g., 110, 300, 508, 608), the operation of which may be controlled by one or more processors (e.g., the processor 301 and/or the like), referred to herein as a “processor.”

In block 802, the processor may receive from a first body-worn video recording device a signal that a trigger event has occurred. For example, the processor may receive a signal from the first body-worn video recording device 102, 200, 502, 602 that the trigger event has occurred.

In block 804, the processor may select one or more second body-worn video recording devices in response to receiving the signal that the trigger event has occurred. In some embodiments, the processor may select the second body-worn video recording devices based on a logical grouping and/or location information related to the first body-worn video recording device and the second body-worn video recording device(s), as further described below.

In block 806, the processor may send activation messages to the selected one or more second body-worn video recording devices to-store images from a respective rolling buffer memory and subsequently captured images in a non-volatile memory. In some embodiments, the processor may send activation messages to the selected one or more second body-worn video recording devices to copy images in the respective rolling buffer memory having a timestamp equal to or after a time value included in the activation messages.

FIGS. 8B-8E are process flow diagrams illustrating operations 800b-800e that may be performed as part of the method 800a for managing a body-worn video recording device according to various embodiments. With reference to FIGS. 1-8E, the operations 800b-800e may be implemented in hardware components and/or software components of a body-worn video recording device (e.g., 102, 104, 106, 200, 402, 404, 406, 502, 504, 506, 602, 604, 606), the operation of which may be controlled by one or more processors (e.g., the processors 212, 214, 301, and/or the like), referred to herein as a “processor.”

Referring to FIG. 8B, after receiving from a first body-worn video recording device a signal that a trigger event has occurred in block 802 as described, the processor may select one or more second body-worn video recording devices associated with a logical group of second body-worn video recording devices in block 810.

The processor may select one or more second body-worn video recording devices in response to receiving the signal that the trigger event has occurred in block 806 as described.

Referring to FIG. 8C, after receiving from a first body-worn video recording device a signal that a trigger event has occurred in block 802 as described, the processor may receive location information regarding the first body-worn video recording device and the one or more second body-worn video recording devices in block 820.

In block 822, the processor may select the one or more second body-worn video recording devices based on location information regarding the first body-worn video recording device and the one or more second body-worn video recording devices.

In block 806, the processor may send activation messages to the selected one or more second body-worn video recording devices to store images from a respective rolling buffer memory and subsequently captured images in a non-volatile memory as described.

Referring to FIG. 8D, after receiving from a first body-worn video recording device a signal that a trigger event has occurred in block 802 as described, the processor may receive location information regarding the first body-worn video recording device and one or more second body-worn video recording devices in block 820 as described.

In block 830, the processor may select one or more second body-worn video recording devices that are within a threshold distance from the first body-worn video recording device.

In block 806, the processor may send activation messages to the selected one or more second body-worn video recording devices to store images from a respective rolling buffer memory and subsequently captured images in a non-volatile memory as described.

In optional block 832, the processor may send activation messages to second body-worn video recording devices to store images from a respective rolling buffer memory and subsequently captured images in a non-volatile memory upon entering the threshold distance from the first body-worn video recording device.

In optional block 834, the processor may send deactivation messages to the second body-worn video recording devices to stop storing images upon leaving the threshold distance from the first body-worn video recording device.

Referring to FIG. 8E, after receiving from a first body-worn video recording device a signal that a trigger event has occurred in block 802 as described, the processor may receive location information regarding the first body-worn video recording device and one or more second body-worn video recording devices in block 820 as described.

In block 840, the processor may select one or more second body-worn video recording devices that are within a geofence area.

In block 806, the processor may send activation messages to the selected one or more second body-worn video recording devices to-store images from a respective rolling buffer memory and subsequently captured images in a non-volatile memory as described.

In optional block 842, the processor may send activation messages to second body-worn video recording devices to store images from a respective rolling buffer memory and subsequently captured images in a non-volatile memory upon entering the geofence area.

In optional block 844, the processor may send deactivation messages to the second body-worn video recording devices to stop storing images upon leaving the geofence area.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more operations of the methods and operations 400, 500, 600, 700a-700f, and 800a-800e may be substituted for or combined with one or more operations of the methods and operations 400, 500, 600, 700a-700f, and 800a-800e.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A body-worn video recording device, comprising:
a camera;
a rolling buffer memory coupled to the camera configured to continuously store a limited duration of images by overwriting stored images that are older than the limited duration;
a wireless transceiver;
a non-volatile memory; and
a processor coupled to the camera, the rolling buffer memory, the wireless transceiver, and the non-volatile memory, the processor configured with processor-executable instructions to perform operations comprising:
continuously storing images captured by the camera in the rolling buffer memory;
determining whether a trigger event has occurred; and
copying images stored in the rolling buffer memory into the non-volatile memory and storing images captured by the camera in the non-volatile memory in response to determining that the trigger event has occurred.

2. The body-worn video recording device of claim 1, wherein the processor is further configured with processor-executable instructions to perform operations such that storing images captured by the camera in the non-volatile memory comprises storing images in the rolling buffer memory and then copying those images from the buffer memory to the non-volatile memory.

3. The body-worn video recording device of claim 1, further comprising a wireless sensor receiver coupled to the processor and configured to receive a signal from a holster sensor indicating that a weapon has been drawn from a holster, wherein the processor is further configured with processor-executable instructions to perform operations such that determining whether a trigger event has occurred comprises receiving a signal by the wireless sensor receiver and determining that the trigger event has occurred in response to the signal indicating that the weapon has been drawn from the holster.

4. The body-worn video recording device of claim 1, further comprising a panic button coupled to the processor, wherein the processor is further configured with processor-executable instructions to perform operations such that determining whether a trigger event has occurred comprises receiving a signal from the panic button and determining that the trigger event has occurred in response to receiving the signal from the panic button.

5. The body-worn video recording device of claim 1, wherein the processor is further configured with processor-executable instructions to perform operations such that determining whether a trigger event has occurred comprises:
receiving an activation signal via the wireless transceiver;
determining whether the activation signal includes an identifier corresponding to the body-worn video recording device; and
determining that the trigger event has occurred in response to determining that the activation signal includes the identifier corresponding to the body-worn video recording device.

6. The body-worn video recording device of claim 5, wherein the processor is further configured with processor-executable instructions to perform operations further comprising changing the identifier corresponding to the body-worn video recording device from time to time.

7. The body-worn video recording device of claim 1, wherein the processor is further configured with processor-executable instructions to perform operations further comprising sending a trigger signal via the wireless transceiver to a second body-worn video recording device in response to determining that the trigger event has occurred.

8. The body-worn video recording device of claim 7, wherein the trigger signal sent to the second body-worn video recording device comprises a unique activation code associated with the second body-worn video recording device.

9. The body-worn video recording device of claim 8, wherein the processor is further configured with processor-executable instructions to perform operations further comprising changing the unique activation code associated with the second body-worn video recording device from time to time.

10. The body-worn video recording device of claim 1, wherein the processor is further configured with processor-executable instructions to perform operations further comprising transmitting images captured by the camera to a network computing device in response to determining that the trigger event has occurred.

11. The body-worn video recording device of claim 10, wherein the processor is further configured with processor-executable instructions to perform operations such that transmitting images captured by the camera to a network computing device in response to determining that the trigger event has occurred comprises:
sending to the network computing device an indication that the trigger event has occurred;
receiving from the network computing device an instruction to transmit the images captured by the camera to the network computing device; and
transmitting the images captured by the camera to the network computing device in response to the instruction from the network computing device.

12. A network computing device, comprising:
a processor configured with processor-executable instructions to perform operations comprising:
receiving from a first body-worn video recording device a signal that a trigger event has occurred;
selecting one or more second body-worn video recording devices in response to receiving the signal that the trigger event has occurred; and
sending activation messages configure to cause the selected one or more second body-worn video recording devices to store images from a respective rolling buffer memory and subsequently captured images in a non-volatile memory.

13. The network computing device of claim 12, wherein the processor is further configured with processor-executable instructions to perform operations such that selecting one or more second body-worn video recording devices in response to receiving the signal that the trigger event has occurred comprises selecting one or more second body-worn video recording devices associated with a logical group of second body-worn video recording devices.

14. The network computing device of claim 12, wherein the processor is configured with processor-executable instructions to perform operations further comprising receiving location information regarding the first body-worn video recording device and the one or more second body-worn video recording devices,
wherein the processor is further configured with processor-executable instructions to perform operations such that selecting one or more second body-worn video recording devices comprises selecting the one or more second body-worn video recording devices based on location information regarding the first body-worn video recording device and the one or more second body-worn video recording devices.

15. The network computing device of claim 14, wherein the processor is further configured with processor-executable instructions to perform operations such that selecting one or more second body-worn video recording devices based on location information regarding the first body-worn video recording device and the one or more second body-worn video recording devices comprises selecting one or more second body-worn video recording devices that are within a threshold distance from the first body-worn video recording device.

16. The network computing device of claim 15, wherein the processor is further configured with processor-executable instructions to perform operations such that sending activation messages configured to cause the selected one or more second body-worn video recording devices to store images from a respective rolling buffer memory and subsequently captured images in the non-volatile memory comprises:
sending activation messages configured to cause second body-worn video recording devices to store images from the respective rolling buffer memory and subsequently captured images in the non-volatile memory upon entering the threshold distance from the first body-worn video recording device; and
sending deactivation messages to the second body-worn video recording devices to stop storing images upon leaving the threshold distance from the first body-worn video recording device.

17. The network computing device of claim 14, wherein the processor is further configured with processor-executable instructions to perform operations such that selecting one or more second body-worn video recording devices in response to receiving the signal that the trigger event has occurred comprises selecting one or more second body-worn video recording devices that are within a geofence area.

18. The network computing device of claim 17, wherein the processor is further configured with processor-executable instructions to perform operations such that sending activation messages to the selected one or more second body-worn video recording devices to store images from a respective rolling buffer memory and subsequently captured images in the non-volatile memory comprises:
sending activation messages to second body-worn video recording devices to store images from a respective rolling buffer memory and subsequently captured images in the non-volatile memory upon entering the geofence area; and
sending deactivation messages to the second body-worn video recording devices to stop storing images upon leaving the geofence area.

19. The network computing device of claim 12, wherein the processor is further configured with processor-executable instructions to perform operations such that sending activation messages to the selected one or more second body-worn video recording devices to copy images from a respective rolling buffer memory and store subsequent captured images in the non-volatile memory comprises sending activation messages to the selected one or more second body-worn video recording devices to copy images in the respective rolling buffer memory having a timestamp equal to or after a time value included in the activation messages.

20. The network computing device of claim 12, wherein the processor is further configured with processor-executable instructions to perform operations further comprising receiving, from one or more of the first body-worn video recording device and the one or more second body-worn video recording devices, images from a respective rolling buffer memory and subsequently captured images.

21. A method for managing a body-worn video recording device performed by a processor of the body-worn video recording device, comprising:
continuously storing images captured by a camera in a rolling buffer memory;
determining whether a trigger event has occurred; and
copying images stored in the rolling buffer memory into a non-volatile memory and storing images captured by the camera in the non-volatile memory in response to determining that the trigger event has occurred.
